(19) United States
(12) Patent Application Publication
(10) Pub. No.: US 2023/0228645 A1
(43) Pub. Date: Jul. 20, 2023

(54) LEAK DETECTION SYSTEM

(71) Applicant: MASTER PLUMBING CORPORATION, San Diego, CA (US)

(72) Inventor: Michael S. Logsdon, SR., San Diego, CA (US)

(21) Appl. No.: 17/580,233

(22) Filed: Jan. 20, 2022

(51) Int. Cl. G01M 3/24; H04R 1/08; H04R 1/10; H04R 29/00

(52) U.S. Cl. CPC G01M 3/24; H04R 1/08; H04R 1/1008; H04R 29/008

(57) ABSTRACT

A device and method for detecting water leaks in building structures relies on sonic and spectral density analyses of sound distortions caused by a subsurface water leak. Structurally, the device includes a microphone connected with a sound amplifier. Also included is a head set and/or a sound analyzer which are respectively connected with the amplifier. In this combination, the microphone is moved across a surface in the building structure to detect an audio signal that is indicative of a subsurface water leak. This audio signal is then aurally evaluated using the headset to identify a sound distortion relative to white noise, or it is visually evaluated by reference to a spectral density presentation of frequencies on the sound analyzer. Operationally, a location of the water leak is determined by moving the microphone along a search pattern of trace lines over the surface being searched until there is a meaningful response.

### FIELD OF THE INVENTION

The present invention pertains to leak detection devices. More particularly, the present invention pertains to leak detection devices that employ sonic and spectral density techniques to differentiate sound distortions for the purpose of detecting water leaks. The present invention is particularly, but not exclusively, useful as a device for detecting sub-surface water leaks in building structures.

### BACKGROUND OF THE INVENTION

Water leaks are a problem wherever and whenever they occur, and they typically involve costly repair. Moreover, the source of a water leak is often difficult to detect. This is particularly the situation when there is no visible water intrusion into an area near the leak, and when the plumbing system has somehow been concealed or isolated during the construction of a building structure. Suffice to say, there are many different causes for water leaks and there are many different scenarios for their detection. The scenarios of interest for the present invention involve audio techniques.

It is well known that a water leak will make a discernable noise. It is also well known that wherever there is a water leak, there will also always be white noise. By definition, “white noise” is a random noise that has a constant energy per unit bandwidth at the frequency in the range of interest. Unlike a water leak, however, white noise has no discernable characteristic. Therefore, in the context of the present invention, white noise will always cause some degree of a masking effect on the water leak noise.

It is also well known that non-random noises, i.e. those with discernable characteristics like water leaks, will exhibit what is referred to here as a spectral density. Succinctly stated, spectral density describes the distribution of power for frequency components, within a range of interest. Importantly, spectral densities are discernable and can be visually displayed. The import for the present invention is that audio signals can be used for aurally and/or visually detecting the location of an otherwise non-observable phenomenon, i.e. a water leak.

With the above in mind, it is an object of the present invention, to provide a device and a methodology for detecting water leaks that rely exclusively on sonic and spectral density determinations. Another object of the present invention is to provide a device and methodology that differentiates an audio signal from white noise to determine the location of an otherwise non-observable water leak. Yet another object of the present invention is to provide a leak detection device and methodology which is easy to use, is simple to manufacture and is commercially cost-effective.

### SUMMARY OF THE INVENTION

In accordance with the present invention, a device for detecting water leaks in the plumbing system of a structure includes a microphone that is electronically connected with a sound amplifier. Specifically, the microphone is adapted to be moved over inside/outside surfaces of the structure to detect audio signals that are indicative of a water leak which is emanating from a subsurface location in the structure.

For one embodiment of the present invention, a headset is connected to the sound amplifier to aurally receive audio signals, some of which may be indicative of a water leak. Of particular interest for this purpose are audio signals that are created by sound distortions such as hissing, humming, dripping, trickling, bubbling, burbling, gargling, gurgling, fluttering, and whistling sounds. In the event, the received audio signal, i.e. sound distortion, is evaluated by discriminating it from white noise. Further, this aural evaluation can detect and determine the location of the water leak in the plumbing system of the structure.

For another embodiment of the present invention, a sound analyzer is connected to the amplifier to detect and determine the location of a water leak. Specifically, with a sound analyzer, sound distortions characterized by frequencies in an audio signal can be identified by their spectral density. These identifications can then be used to provide a visual presentation of frequencies in the audio signal. Preferably, the sound analyzer is a commercially available computer software application that is adapted for display on a cell phone.

As envisioned for the present invention, either an aural evaluation of audio signals can be made using a headset, or a visual presentation of the audio signals can be provided by a sound analyzer. This is an either-or possibility. However, a preferred embodiment of the present invention provides for the combined use of both a headset (aural) and a sound analyzer (visual). This combination then provides for a simultaneous aural evaluation, which is complemented by a visual presentation, to thereby provide for a redundant detection of the location of a water leak.

Operationally, the location of the water leak is indicated by the location of the microphone on the surface during receipt of the audio signal. Further, movements of the microphone are based on a search pattern of trace lines that are extrapolated onto the surface of the structure for use in guiding the microphone over the surface of the structure being searched. As envisioned for the present invention, the search pattern can be determined in any of several ways. For one, the search pattern can be derived from construction plans of the structure. For another, the search pattern can be based merely on identifiable features of the surface. In any event, the search pattern will be somehow predetermined.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a system for detecting water leaks in accordance with the present invention;

FIG. 2 is a frequency graph of sound wave power showing the spectral density of a sound distortion in the presence of white noise; and

FIG. 3 shows an interior portion of a building structure with an extrapolated search pattern of trace lines superposed on surfaces of the building structure.

### DESCRIPTION OF THE PREFERRED EMBODIMENTS

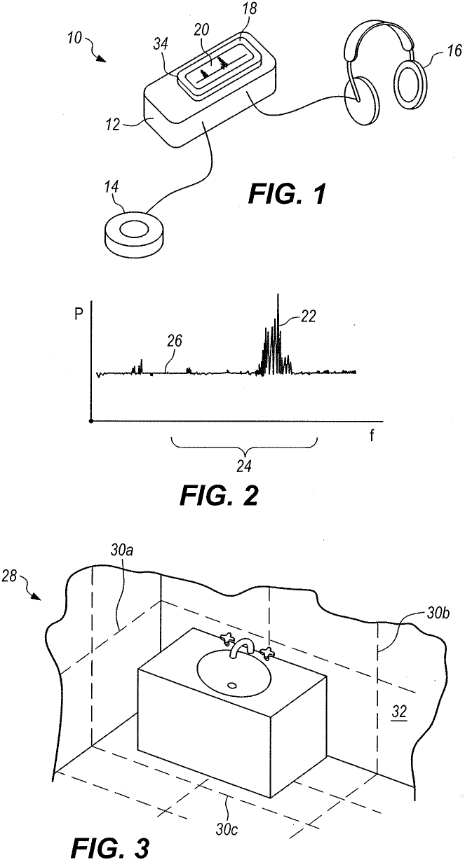

Referring initially to FIG. 1, a system for detecting water leaks is shown and is generally designated 10. As shown, the system 10 includes a sound amplifier 12 which is electronically connected with a microphone 14 and a headset 16. Also shown in FIG. 1 is a sound analyzer 18 which can be selectively connected to the sound amplifier 12. Alternatively, the sound analyzer 18 may be incorporated as a component of the sound amplifier 12. For purposes of the present invention, the headset 16 is adapted to be worn by a user (not shown).

The sound analyzer 18 will include a display 20 which provides a visual presentation of power in audio signals according to frequencies in the signal. For example, the spectral density 22 shown in FIG. 2 is a visual presentation of a sound distortion having discernable power fluctuations for frequencies that occur within a frequency range of interest 24. The spectral density 22 in an audio signal will, however, differ depending on the nature of the sound distortion. In the context of the present invention, typical sounds for water leaks can be variously characterized as hissing, humming, dripping, trickling, bubbling, burbling, gargling, gurgling, fluttering, and whistling sounds. Nevertheless, although their spectral density 22 may vary from one another, a water leak is still detectable. This is so because the distinctive power fluctuations for the spectral density 22 of all non-observable water leaks, will typically occur at a location in a building structure 28 where the background is essentially nothing but white noise 26. As represented in FIG. 2, a spectral density 22 which is characterized by increased power levels, is easily distinguished from white noise 26, which has a substantially constant power level.

For the present invention, the detection of a water leak can be accomplished by either an aural evaluation of the leak using the headset 16, or with a visual presentation of the leak’s spectral density 22 on the display 20 of the sound analyzer 18. Preferably, the simultaneously use of both an aural evaluation and a visual presentation is employed to achieve redundancy for the leak detection operation.

In an operation of the system 10, portions of a building structure 28 are inspected by moving the microphone 14 along trace lines 30 over surfaces 32 of the building structure 28. The trace lines 30a-c, shown in FIG. 3, are only exemplary. Specifically, the trace lines 30 will be arranged in an arbitrary search pattern which is mentally extrapolated onto surfaces 32 of the building structure 28, e.g. walls, floors and ceiling. As envisioned for the present invention, the search pattern can be derived from construction plans of the structure 28, or it can be based on identifiable features of the surface 32, or both. In the event, the search pattern of trace lines 30 will somehow be predetermined for extrapolation.

As envisioned for the system 10, the sound analyzer 18 may be a cell phone 34 that includes a computer with a software application which is adapted for creating the display 20 (see FIG. 1). Thus, in combination, the headset 16 the sound analyzer 18 will operate simultaneously to detect a water leak. On the other hand, the location of the microphone 14 will specifically identify the location of the water leak.

While the particular Leak Detection System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for detecting water leaks in a plumbing system of a structure which comprises:
a sound amplifier;
a microphone electronically connected with the sound amplifier, wherein the microphone is adapted to be moved over a surface of the structure to detect an audio signal indicative of a water leak emanating from a subsurface location in the structure; and
a headset connected with the sound amplifier and adapted for wear by a user to aurally receive the audio signal for an evaluation thereof by discriminating the audio signal from white noise, to thereby detect the location of a water leak in the plumbing system of the structure.

2. The device of claim 1 further comprising a sound analyzer mounted on the device, wherein the sound analyzer is connected with the amplifier to provide a visual presentation of frequencies in the audio signal for simultaneous evaluation with the aural evaluation to thereby detect the location of the water leak.

3. The device of claim 1 wherein the sound analyzer is a computer software application adapted for display on a cell phone.

4. The device of claim 1 wherein the location of the water leak is indicated by the location of the microphone on the surface during receipt of the audio signal.

5. The device of claim 1 further comprising a search pattern of trace lines extrapolated onto the surface of the structure for use in guiding the microphone over the surface of the structure being searched.

6. The device of claim 5 wherein the search pattern is predetermined.

7. The device of claim 5 wherein the search pattern is derived from construction plans of the structure.

8. The device of claim 5 wherein the search pattern is based on identifiable features of the surface.

9. The device of claim 1 wherein the audio signal is a sound distortion selected from the group consisting of hissing, humming, dripping, trickling, bubbling, burbling, gargling, gurgling, fluttering and whistling.

10. A device for detecting water leaks in a plumbing system of a structure which comprises:
a sound amplifier;
a microphone electronically connected with the sound amplifier, wherein the microphone is adapted to be moved over a surface of the structure to detect an audio signal indicative of a water leak emanating from a subsurface location in the structure; and
a sound analyzer mounted on the device, wherein the sound analyzer is connected with the amplifier to provide a visual presentation of frequencies in the audio signal to thereby detect the location of the water leak.

11. The device of claim 10 further comprising a headset connected with the amplifier and adapted for wear by a user to receive the audio signal for an aural evaluation thereof by discriminating the audio signal from white noise, for simultaneous evaluation with the visual presentation of the sound analyzer to thereby detect the location of a water leak in the plumbing system of the structure.

12. The device of claim 11 further comprising a search pattern of trace lines extrapolated onto the surface of the structure for use in guiding the microphone over the surface of the structure being searched.

13. The device of claim 11 wherein the search pattern is predetermined.

14. The device of claim 11 wherein the search pattern is derived from construction plans of the structure.

15. The device of claim 11 wherein the search pattern is based on identifiable features of the surface.

16. The device of claim 10 wherein the structure is a building.

17. A method for detecting water leaks in a plumbing system of a structure which comprises the steps of:
providing a sound amplifier;
connecting a microphone with the sound amplifier, wherein the microphone is adapted to be moved over a surface of the structure to detect an audio signal indicative of a water leak emanating from a subsurface location in the structure;
adapting a headset connected with the amplifier for wear by a user to aurally receive the audio signal for an evaluation thereof by discriminating the audio signal from white noise;
engaging a sound analyzer for connection with the amplifier to provide a visual presentation of frequencies in the audio signal; and
simultaneously assessing the visual presentation with the aural evaluation to thereby detect the location of the water leak in the plumbing system of the structure.

18. The method of claim 17 further comprising the step of extrapolating a search pattern of trace lines onto the surface of the structure for use in guiding the microphone over the surface of the structure being searched.

19. The method of claim 18 further comprising the step of identifying features of the surface for identifying the search pattern.

20. The method of claim 18 wherein the search pattern is predetermined.
